(19) United States
(12) Patent Application Publication
(10) Pub. No.: US 2019/0271985 A1
(43) Pub. Date: Sep. 5, 2019

(54) VEHICLE CONTROL SYSTEM, VEHICLE CONTROL METHOD, AND VEHICLE CONTROL PROGRAM

(71) Applicant: HONDA MOTOR CO., LTD., Minato-ku, Tokyo (JP)

(72) Inventors: Yoshitaka Mimura, Wako-shi (JP); Kentaro Ishisaka, Wako-shi (JP); Masahiko Shimada, Wako-shi (JP)

(21) Appl. No.: 16/345,267

(22) PCT Filed: Nov. 11, 2016
(86) PCT No.: PCT/JP2016/083519

§ 371 Date: Apr. 26, 2019

(51) Int. Cl. G05D 1/02; G05D 1/00; G01C 21/36; B60W 50/14

(52) U.S. Cl. CPC G05D 1/0214; G05D 1/0088; G01C 21/3664; B60W 2050/146; B60W 50/14; G05D 1/0061; G05D 2201/0213; G01C 21/3667

(57) ABSTRACT

A vehicle control system includes: an external-world recognition unit configured to recognize a position of a peripheral vehicle of a vehicle; a trajectory generation unit configured to generate a plurality of trajectory candidates based on the position of the peripheral vehicle recognized by the external-world recognition unit; and a display control unit configured to cause a display unit to display an image indicating a trajectory along which the vehicle is able to travel and a trajectory along which the vehicle is not able to travel among the plurality of trajectory candidates generated by the trajectory generation unit.

### TECHNICAL FIELD

The present invention relates to a vehicle control system, a vehicle control method, and a vehicle control program.

### BACKGROUND ART

In recent years, studies of technologies for generating for a plurality of target trajectory candidates used for vehicles to arrive at destinations and performing automated driving of the vehicles along target trajectories selected from the generated plurality of candidates or switching the automated driving to manual driving in states in which the automated driving is not possible have been in progress. In association with such studies, a technology for setting a plurality of handover permission sections in which automated driving can be handed over to manual driving as recommendation handover sections has been disclosed (for example, see Patent Literature 1).

### CITATION LIST

### Patent Literature

### Patent Literature 1

Japanese Unexamined Patent Application, First Publication No. 2016-097770

### SUMMARY OF INVENTION

### Technical Problem

However, in the technology of the related art, an occupant is notified of only information regarding a target trajectory selected from a plurality of target trajectory candidates Therefore, the occupant may not know target trajectory candidates generated as other target trajectory candidates and a result regarding whether travel is possible for each target trajectory. Accordingly, the occupant may not ascertain a situation of a vehicle during automated driving more specifically and a sense of security of the automated driving may not be obtained in some cases.

The present invention is devised in view of such circumstances and one object of the present invention is to provide a vehicle control system, a vehicle control method, and a vehicle control program capable of improving a sense of security of automated driving for an occupant.

### Solution to Problem

According to the present invention of claim 1, there is provided a vehicle control system including: an external-world recognition unit (121) configured to recognize a position of a peripheral vehicle of a vehicle; a trajectory generation unit (123) configured to generate a plurality of trajectory candidates based on the position of the peripheral vehicle recognized by the external-world recognition unit; and a display control unit (125) configured to cause a display unit to display an image indicating a trajectory along which the vehicle is able to travel and a trajectory along which the vehicle is not able to travel among the plurality of trajectory candidates generated by the trajectory generation unit.

According to the present invention of claim 2, in the vehicle control system according to claim 1, the display control unit may cause the display unit to display an image in which information indicating that the vehicle is not able to travel is associated with the trajectory along which the vehicle is not able to travel.

According to the present invention of claim 3, in the vehicle control system according to claim 1, the display control unit may cause the display unit to display an image in which information indicating that the vehicle is not able to travel is associated with a peripheral vehicle which prevents the vehicle from traveling with regard to the trajectory along which the vehicle is not able to travel.

According to the present invention of claim 4, in the vehicle control system according to claim 1, the display control unit may cause the display unit to display an image in which information indicating that the vehicle is not able to travel is associated with a position of a lane change destination of the vehicle with regard to the trajectory along which the vehicle is not able to travel.

According to the present invention of claim 5, in the vehicle control system according to claim 1, the display control unit may cause the display unit to display an image in which between the trajectory along which the vehicle is able to travel and the trajectory along which the vehicle is not able to travel are alternately switched.

According to the present invention of claim 6, in the vehicle control system according to claim 1, the display control unit may cause the display unit to display the image indicating the trajectory along which the vehicle is able to travel and the trajectory along which the vehicle is not able to travel when a predetermined event is activated and may further display an image indicating a timing at which it is confirmed whether the predetermined event is performed on the display unit.

According to the present invention of claim 7, in the vehicle control system according to claim 6, the display control unit may perform a request for allowing an occupant of the vehicle to perform manual driving when the timing at which it is confirmed whether the predetermined event is activated arrives in a state in which the vehicle is not able to travel along a trajectory suitable for a route to a preset destination among the plurality of trajectory candidates generated by the trajectory generation unit.

According to the present invention of claim 8, the vehicle control system according to claim 7 may further include an automated driving control unit (121, 122, 123, 124, and 131) configured to perform automated driving of the vehicle based on a trajectory generated by the trajectory generation unit. The automated driving control unit may continue the automated driving along the trajectory along which the vehicle is able to travel and which is displayed on the display unit when a cancellation operation of cancelling the request is received.

According to the present invention of claim 9, in the vehicle control system according to claim 8, the display control unit may further cause the display unit to present a GUI switch for cancelling the request when the display unit is caused to display information regarding a request for allowing an occupant of the vehicle to perform manual driving, and the automated driving control unit may perform the automated driving along a trajectory other than a trajectory suitable for a route to a preset destination when a cancellation operation of cancelling the request is received through the GUI switch.

According to the present invention of claim 10, there is provided a vehicle control method including: recognizing a position of a peripheral vehicle of a vehicle by an in-vehicle computer; generating a plurality of trajectory candidates based on the recognized position of the peripheral vehicle by the in-vehicle computer; and causing a display unit to display an image indicating a trajectory along which the vehicle is able to travel and a trajectory along which the vehicle is not able to travel among the plurality of generated trajectory candidates by the in-vehicle computer.

According to the present invention of claim 11, there is provided a vehicle control program causing an in-vehicle computer to: recognize a position of a peripheral vehicle of a vehicle; generate a plurality of trajectory candidates based on the recognized position of the peripheral vehicle; and cause a display unit to display an image indicating a trajectory along which the vehicle is able to travel and a trajectory along which the vehicle is not able to travel among the plurality of generated trajectory candidates.

### Advantageous Effects of Invention

According to the present invention according to claims 1, 4, 10, and 11, the occupant can ascertain the target trajectory candidates at the current time. Since the trajectories along which the own vehicle M is able to travel and the trajectories along which the own vehicle M is not able to travel are displayed, the occupant can ascertain, for example, a situation of the vehicle during the automated driving more specifically. Accordingly, it is possible to improve a sense of safety of the occupant.

According to the present invention according to claim 2, the occupant can easily ascertain the trajectories along which the vehicle is not able to travel among the plurality of displayed trajectory candidates.

According to the present invention according to claim 3, the occupant can easily ascertain the peripheral vehicles which prevent the vehicle from traveling. Accordingly, for example, when the driving mode of the own vehicle M is switched from the automated driving to the manual driving, the occupant can smoothly perform the switching to the manual driving while being careful of the peripheral vehicles.

According to the present invention according to claim 5, the occupant easily distinguishes the trajectories along which the vehicle is able to travel from the trajectories along which the vehicle is not able to travel.

According to the present invention according to claim 6, the occupant can easily ascertain a timing at which it is confirmed whether a predetermined event is performed.

According to the present invention according to claim 7, the occupant can be notified so that the occupant performs the manual driving at an appropriate timing.

According to the present invention according to claims 8 and 9, the automated driving of the vehicle can be continued through a simple operation on a driving operator, a mechanical switch, a GUI switch, or the like.

### BRIEF DESCRIPTION OF DRAWINGS

FIG. 1 is a diagram illustrating a configuration of a vehicle system 1 including an automated driving control unit 100.

FIG. 2 is a diagram illustrating an aspect in which a relative position and an attitude of an own vehicle M with respect to a travel lane L1 are recognized by the own vehicle position recognition unit 122.

FIG. 3 is a diagram illustrating an aspect in which a target trajectory is generated based on a recommended lane.

FIG. 4 is a diagram illustrating an example of a target trajectory candidate generated by an action plan generation unit 123.

FIG. 5 is a diagram illustrating examples of a plurality of target trajectory candidates displayed on a display device 31.

FIG. 6 is a diagram illustrating an example in which an image in which information indicating whether travel is possible is indicated by a mark on a road of a lane change destination is displayed.

FIG. 7 is a diagram illustrating an example in which an image indicating a target trajectory and an image indicating that the vehicle is able to travel or not able to travel are displayed to overlap.

FIG. 8 is a diagram illustrating a display example of information regarding a handover request.

FIG. 9 is a diagram illustrating a display example of a target trajectory for an emergency stop.

FIG. 10 is a flowchart illustrating an example of a vehicle control process according to an embodiment.

### DESCRIPTION OF EMBODIMENTS

Hereinafter, embodiments of a vehicle control system, a vehicle control method, and a vehicle control program of the present invention will be described with reference to the drawings.

### Overall Configuration

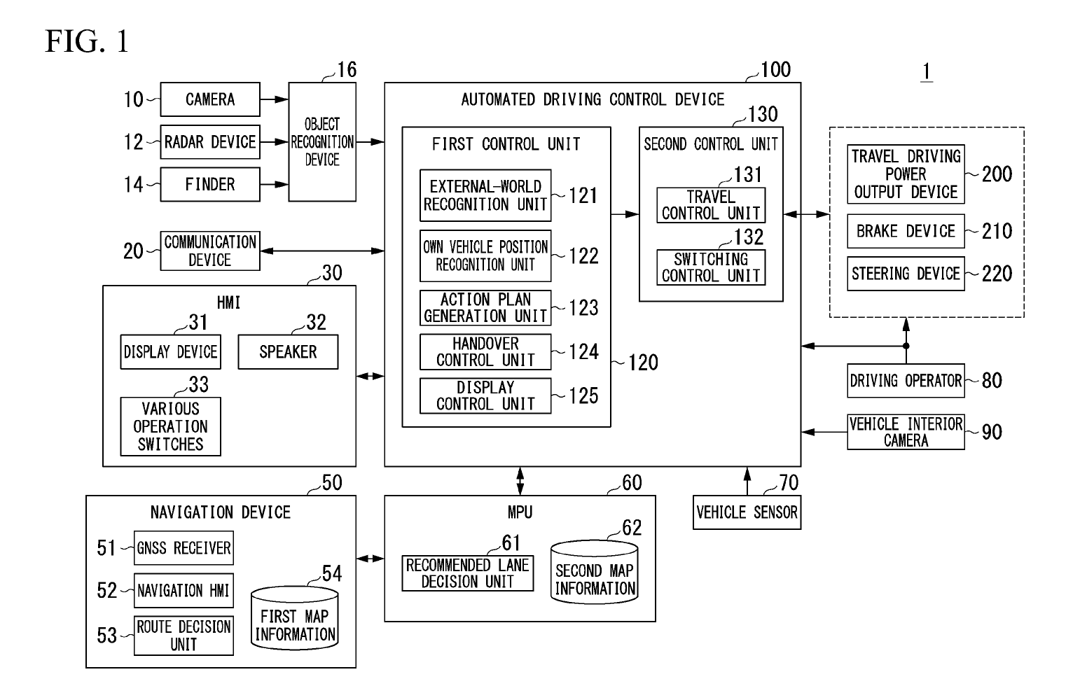

FIG. 1 is a diagram illustrating a configuration of a vehicle system 1 including an automated driving control unit 100. A vehicle on which the vehicle system 1 is mounted is, for example, a vehicle such as a two-wheeled vehicle, a three-wheeled vehicle, or a four-wheeled vehicle. A driving source of the vehicle includes an internal combustion engine such as a diesel engine or a gasoline engine, an electric motor, and a combination thereof. The electric motor operates using power generated by a power generator connected to the internal combustion engine or power discharged from a secondary cell or a fuel cell.

The vehicle system 1 includes, for example, a camera 10, a radar device 12, a finder 14, an object recognition device 16, a communication device 20, a human machine interface (HMI) 30, a navigation device 50, a micro processing unit (MPU) 60, a vehicle sensor 70, a driving operator 80, a vehicle interior camera 90, an automated driving control unit 100, a travel driving power output device 200, a brake device 210, and a steering device 220. The devices and units are connected to each other via a multiplex communication line such as a controller area network (CAN) communication line, a serial communication line, or a wireless communication network. The configuration illustrated in FIG. 1 is merely exemplary, a part of the configuration may be omitted, and another configuration may be further added.

The “vehicle control system” includes, for example, the camera 10, the radar device 12, the finder 14, the object recognition device 16, the communication device 20, the HMI 30, the MPU 60, the vehicle sensor 70, the driving operator 80, and the automated driving control unit 100.

The camera 10 is, for example, a digital camera that uses a solid-state image sensor such as a charged coupled device (CCD) or a complementary metal oxide semiconductor (CMOS). The single camera 10 or the plurality of cameras 10 are mounted on any portion of the vehicle in which the vehicle system 1 is mounted (hereinafter referred to as an own vehicle M). In the case of forward imaging, the camera 10 is mounted on an upper portion of a front windshield, a rear surface of a rearview mirror, or the like. In the case of backward imaging, the camera 10 is mounted on an upper portion of a rear windshield, a backdoor, or the like. In the case of side imaging, the camera 10 is mounted on a door mirror or the like. For example, the camera 10 repeatedly images the periphery of the own vehicle M periodically. The camera 10 may be a stereo camera.

The radar device 12 radiates radio waves such as millimeter waves to the periphery of the own vehicle M and detects radio waves (reflected waves) reflected from an object to detect at least a position (a distance and an azimuth) of the object. The single radar device 12 or the plurality of radar devices 12 are mounted on any portion of the own vehicle M. The radar device 12 may detect a position and a speed of an object in conformity with a frequency modulated continuous wave (FMCW) scheme.

The finder 14 is a light detection and ranging or a laser imaging detection and ranging (LIDAR) finder that measures scattered light of radiated light and detects a distance to a target. The single finder 14 or the plurality of finders 14 are mounted on any portion of the own vehicle M.

The object recognition device 16 performs a sensor fusion process on detection results from some or all of the camera 10, the radar device 12, and the finder 14 and recognizes a position, a type, a speed, and the like of an object. The object recognition device 16 outputs a recognition result to the automated driving control unit 100.

The communication device 20 communicates with other vehicles around the own vehicle M using, for example, a cellular network, a Wi-Fi network, Bluetooth (registered trademark), dedicated short range communication (DSRC), or the like or communicates with various server devices via wireless base stations.

The HMI 30 suggests various types of information to occupants of the own vehicle M and receives input operations by the occupants. The HMI 30 includes, for example, a display device (display unit) 31, a speaker 32, and various operation switches 33. The display device 31 is a liquid crystal display (LCD) or organic electro-luminescence (EL) display device or the like. The display device 31 is, for example, a touch panel display device that has a function of displaying an image and a function of receiving operation content or an approach position of a finger of an operant on a display surface. For example, the speaker 32 outputs a sound based on content displayed on the display device 31 or outputs a warning or the like.

The various operation switches 33 are disposed on any portion in the own vehicle M. The various operation switches 33 include, for example, automated driving switches. The automated driving switches are switches that indicate start (or future start) and stop of automated driving. The automated driving refers to, for example, automated control of at least one of speed control and steering control of the own vehicle M. The various operation switches 33 may be graphical user interface (GUI) switches or mechanical switches. The HMI 30 may have a mailing function of transmitting and receiving electronic mails to and from the outside or a calling function of performing a call through the communication device 20 in addition to the above-described configuration.

The navigation device 50 includes, for example, a global navigation satellite system (GNSS) receiver 51, a navigation HMI 52, and a route decision unit 53 and retains first map information 54 in a storage device such as a hard disk drive (HDD) or a flash memory. The GNSS receiver 51 specifies a position of the own vehicle M based on signals received from GNSS satellites. The position of the own vehicle M may be specified or complemented by an inertial navigation system (INS) using an output of the vehicle sensor 70. The navigation HMI 52 includes a display device, a speaker, a touch panel, and a key. The navigation HMI 52 may be partially or entirely common to the above-described HMI 30. The route decision unit 53 decides, for example, a route from a position of the own vehicle M specified by the GNSS receiver 51 (or any input position) to a destination input by an occupant using the navigation HMI 52 with reference to the first map information 54. The first map information 54 is, for example, information in which a road form is expressed by links indicating roads and nodes connected by the links. The first map information 54 may include curvatures of roads and point of interest (POI) information. The route decided by the route decision unit 53 is output to the MPU 60. The navigation device 50 may perform route guidance using the navigation HMI 52 based on the route decided by the route decision unit 53. The navigation device 50 may be realized by, for example, a function of a terminal device such as a smartphone or a tablet terminal possessed by a user. The navigation device 50 may transmit a current position and a destination to a navigation server via the communication device 20 to acquire a route replied from the navigation server.

The MPU 60 functions as, for example, a recommended lane decision unit 61 and retains second map information 62 in a storage device such as an HDD or a flash memory. The recommended lane decision unit 61 divides a route provided from the navigation device 50 into a plurality of blocks (for example, divides the route in a vehicle movement direction for each 100 [m]) and decides a recommended lane for each block with reference to the second map information 62. The recommended lane decision unit 61 decides in which lane the vehicle travels from the left. When there is a branching spot a joining spot, or the like on the route, the recommended lane decision unit 61 decides a recommended lane so that the own vehicle M can travel along a reasonable travel route for moving to a branching destination.

The second map information 62 is map information with higher precision than the first map information 54. The second map information 62 includes, for example, information regarding the middles of lanes or information regarding boundaries of lanes. The second map information 62 may include road information, traffic regulation information, address information (address and postal number), facility information, and telephone number information. The road information includes information indicating kinds of roads such as expressways, roll roads, national ways, or prefecture roads and information such as the number of lanes of a road, emergency parking areas, the width of each lane, the gradients of roads, the positions of roads (3-dimensional coordinates including longitude, latitude, and height), curvatures of curves of lanes, positions of joining and branching points of lanes, and signs installed on roads. The second map information 62 may be updated frequently when the communication device 20 are used to access other devices.

The vehicle sensor 70 includes a vehicle speed sensor that detects a speed of the own vehicle M, an acceleration sensor that detects acceleration, a yaw rate sensor that detects an angular velocity around a vertical axis, and an azimuth sensor that detects a direction of the own vehicle M.

The driving operator 80 includes, for example, an accelerator pedal, a brake pedal, a shift lever, a steering wheel, and other operators. A sensor that detects whether there is an operation or an operation amount is mounted on the driving operator 80 and a detection result is output to the automated driving control unit 100 or some or all of the travel driving power output device 200, the brake device 210, and the steering device 220.

The vehicle interior camera 90 images the upper half body of an occupant sitting on a driving seat centering on his or her face. An image captured by the vehicle interior camera 90 is output to the automated driving control unit 100.

### Automated Driving Control Unit

The automated driving control unit 100 includes, for example, a first control unit 120 and a second control unit 130. Each of the first control unit 120 and the second control unit 130 is realized, for example, by causing a processor such as a central processing unit (CPU) to execute a program (software). Some or all of the function units of the first control unit 120 and the second control unit 130 to be described below may be realized by hardware such as a large scale integration (LSI), an application specific integrated circuit (ASIC), or a field-programmable gate array (FPGA), or may be realized by software and hardware in cooperation.

A unit including some or all of an external-world recognition unit 121, an own vehicle position recognition unit 122, an action plan generation unit 123, and a handover control unit 124 of the first control unit 120, and a travel control unit 131 of the second control unit 130 to be described below is an example of an “automated driving control unit.” The automated driving control unit automatically controls, for example, at least one of steering and an accelerated or decelerated speed of the own vehicle M and performs automated driving of the own vehicle M.

The first control unit 120 includes, for example, the external-world recognition unit 121, the own vehicle position recognition unit 122, the action plan generation unit (trajectory generation unit) 123, the handover control unit 124, and a display control unit 125.

The external-world recognition unit 121 recognizes states such as positions of peripheral vehicles and speeds, acceleration, or the like thereof based on information input from the camera 10, the radar device 12, and the finder 14 via the object recognition device 16. The positions of the peripheral vehicles may be represented as representative points such as centers, corners, or the like of the peripheral vehicles or may be represented as regions expressed by contours of the peripheral vehicles. The “states” of the peripheral vehicles may include acceleration or jerk of the peripheral vehicles or “action states” (for example, whether the peripheral vehicles are changing their lanes or are attempting to change their lanes).

The external-world recognition unit 121 may recognize guardrails, electric poles, parked vehicles, pedestrians, and other objects in addition to the peripheral vehicles.

The own vehicle position recognition unit 122 recognizes, for example, a lane along which the own vehicle M is traveling (a travel lane) and a relative position and an attitude of the own vehicle M with respect to the travel lane. The own vehicle position recognition unit 122 recognizes, for example, the travel lane by comparing patterns of road mark lines (for example, arrangement of continuous lines and broken lines) obtained from the second map information 62 with patterns of road mark lines around the own vehicle M recognized from images captured by the camera 10. In this recognition, the position of the own vehicle M acquired from navigation device 50 or a process result by INS may be added.

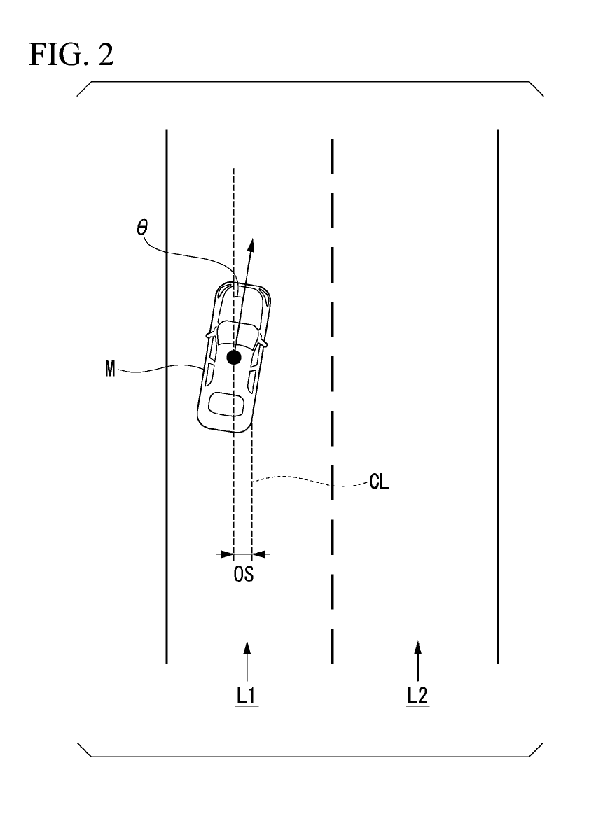

Then, the own vehicle position recognition unit 122 recognizes, for example, a position or an attitude of the own vehicle M with respect to a travel lane. FIG. 2 is a diagram illustrating an aspect in which a relative position and an attitude of an own vehicle M with respect to a travel lane L1 are recognized by the own vehicle position recognition unit 122. The own vehicle position recognition unit 122 recognizes, for example, a separation OS from a travel lane center CL of a reference point (for example, a center) of the own vehicle M and an angle θ formed with respect to a line drawn with the travel lane center CL in the movement direction of the own vehicle M as the relative position and the attitude of the own vehicle M with respect to the travel lane L1. Instead of this, the own vehicle position recognition unit 122 may recognize a position or the like of the reference point of the own vehicle M with respect to one side end of the travel lane L1 as the relative position of the own vehicle M with respect to the travel lane. The relative position of the own vehicle M recognized by the own vehicle position recognition unit 122 is supplied to the recommended lane decision unit 61 and the action plan generation unit 123.

### Action Plan

The action plan generation unit 123 generates an action plan for the own vehicle M that performs automated driving or manual driving to a destination or the like. For example, the action plan generation unit 123 decides events which are sequentially performed in automated driving so that the own vehicle M travels along the recommended lane decided by the recommended lane decision unit 61 and peripheral situations of the own vehicle M can be handled. As the events, for example, there are a constant speed traveling event for traveling at a constant speed along the same travel lane, a track traveling event for tracking a front traveling vehicle, a lane changing event, a joining event, a branching event, an emergent stopping event, and a handover event for ending automated driving to switch to manual driving. When such an event is active or while such an event is performing, an action for avoidance is planned in some cases on the basis of a peripheral situation (presence of a peripheral vehicle or a pedestrian, contraction of a lane due to road construction, or the like) of the own vehicle M.

The action plan generation unit 123 generates a target trajectory along which the own vehicle M travels in future. The target trajectory includes, for example, a speed component. For example, the target trajectory is generated as a set of target spots (trajectory points) at which the own vehicle arrives at reference times when the plurality of future reference times are set for each predetermined sampling time (for example, about 0 decimal point [sec]). Therefore, when a width between the trajectory points is broad, the width indicates a section between the trajectory points in which the own vehicle is traveling at a high speed.

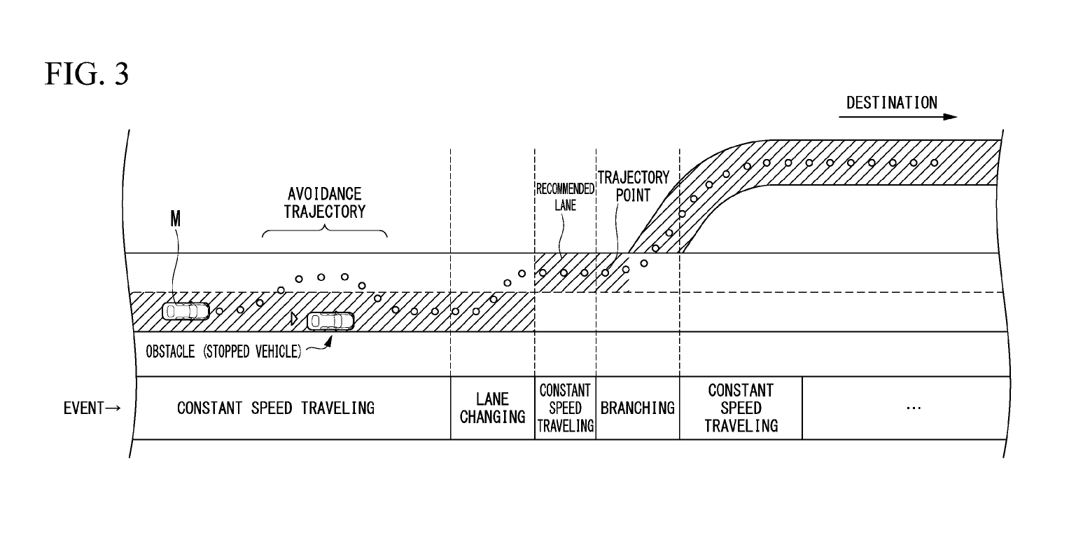

FIG. 3 is a diagram illustrating an aspect in which a target trajectory is generated based on a recommended lane. As illustrated, the recommended lane is set to be convenient for traveling along a route to a designation. The action plan generation unit 123 actives a lane changing event, a branching event, a joining event, or the like when the own vehicle arrives by a predetermined distance of a switching spot of the recommended lane (which may be decided in accordance with a type of event). When it is necessary to avoid an obstacle while each event is performed, an avoidance trajectory is generated, as illustrated.

The action plan generation unit 123 generates, for example, a plurality of target trajectory candidates and selects an optimum target trajectory suitable for a route to the destination at that time on the basis of a viewpoint for safety and efficiency.

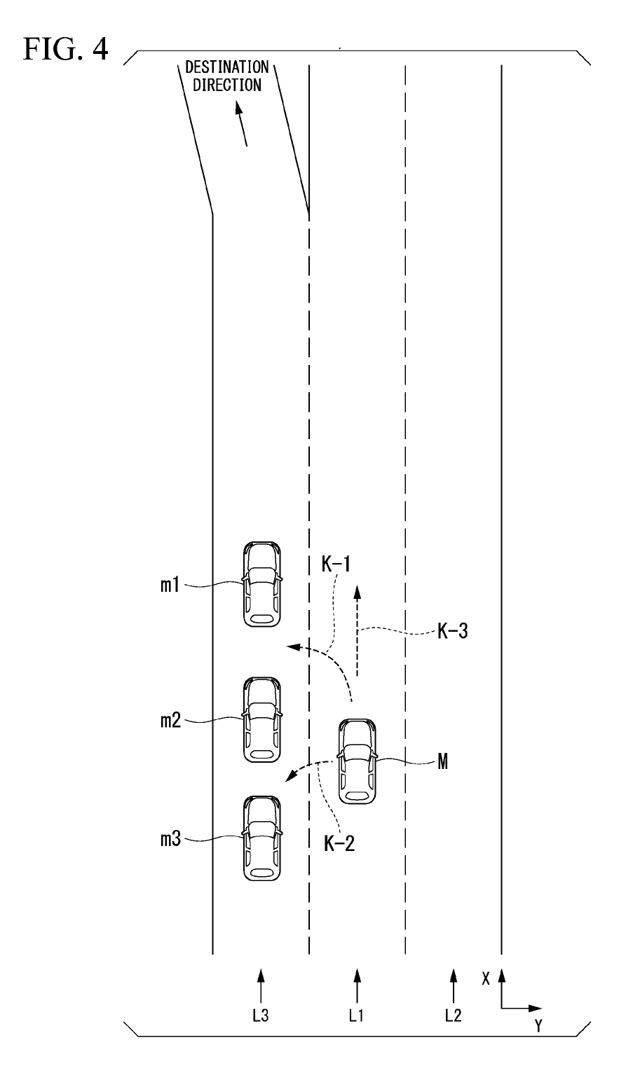

FIG. 4 is a diagram illustrating an example of a target trajectory candidate generated by the action plan generation unit 123. For example, the action plan generation unit 123 generates a plurality of target trajectories K-1 to K-3 including a case in which the own vehicle M attempts to change the travel lane L1 to a travel lane L3 in accordance with a lane changing event in the route to the destination of the own vehicle M, a case in which the own vehicle M changes the lane from the travel lane L1 to the travel lane L3, and a case in which the own vehicle M does not change the lane, as the target trajectory candidates. In the drawing, the target trajectories K-1 to K-2 are target trajectories of the cases in which the own vehicle M changes the lane and the target trajectory K-3 is a target trajectory of the case in which the own vehicle M does not change the lane.

The action plan generation unit 123 determines whether the own vehicle M is able to travel in each of the target trajectories based on a relation with peripheral vehicles m1 to m3 (which refers to a positional relation or a speed relation).

In the example of FIG. 4, the action plan generation unit 123 determines that the vehicle is not able to travel along the target trajectories K-1 and K-2 and change the lane since an inter-vehicle distance of each of the peripheral vehicles m1 to m3 is short. Accordingly, the action plan generation unit 123 decides the target trajectory K-3 as a target trajectory.

The action plan generation unit 123 supplies the display control unit 125 with a result obtained by determining whether the vehicle is able to travel along the plurality of generated target trajectories K-1 to K-3. Note that, in the following description, “travel possibility” refers to a state in which the own vehicle M can be caused to travel along a specific target trajectory through automated driving, auxiliary driving assistance control, or the like. “Travel impossibility” refers to a state in which the own vehicle M cannot be caused to travel along a specific target trajectory through automated driving, auxiliary driving assistance control, or the like.

### Handover Control

The handover control unit 124 performs handover control for transitioning a driving mode from automated driving to manual driving in an end schedule spot or the like of the automated driving set by an action plan or the like generated by the action plan generation unit 123. The handover control is, for example, control in which the driving mode of the own vehicle M is switched from the automated driving to the manual driving when an occupant is notified of a handover request and the occupant operates in response to the handover request of which he or she is notified (more specifically, when an operation of a predetermined amount or more continues for a predetermined time).

The handover control unit 124 outputs a switching instruction to switch the driving mode of the own vehicle M from the automated driving to the manual driving to the switching control unit 132 to be described below when the automated driving is forcibly ended at the end spot.

For example, the handover control unit 124 performs the handover control at a predetermined timing in a state in which the own vehicle M is not able to travel along the target trajectory. The handover control unit 124 instructs the switching control unit 132 to be described below to switch the driving mode of the own vehicle M from the automated driving to the manual driving when the occupant performs an operation in response to the handover request.

The handover control unit 124 generates information regarding a timing at which the handover request starts and a timing at which handover is completed and supplies the generated information to the display control unit 125 when the handover request is notified of. The significance of this process will be described later.

The handover control unit 124 instructs the action plan generation unit 123 to generate a target trajectory for an emergency stop when there is no response of the occupant to the above-described handover request or no operation on the driving operator 80 and the timing at which the handover is completed arrives. In this way, it is possible to ensure safety of the occupant by performing control for causing the own vehicle M to perform the emergency stop in a state in which the automated driving may not continue.

### Display Control

The display control unit 125 controls display content of the display device 31 based on information supplied from the action plan generation unit 123, the handover control unit 124, and the like. For example, the display control unit 125 causes the display device 31 to display an image indicating a plurality of target trajectory candidates generated by the action plan generation unit 123.

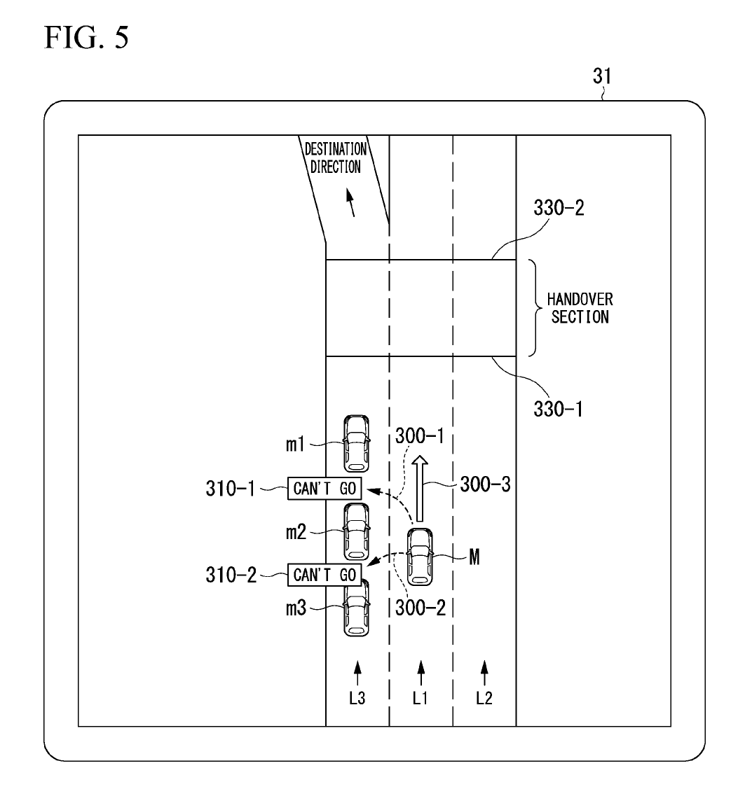

FIG. 5 is a diagram illustrating examples of a plurality of target trajectory candidates displayed on a display device 31. First, the display control unit 125 acquires a map image of the periphery of the own vehicle M from the second map information 62 based on positional information of the own vehicle M. Then, the display control unit 125 causes the display device 31 to display an image in which an image indicating the own vehicle M, an image indicating each of the peripheral vehicles m1 to m3, and an image indicating the plurality of target trajectory candidates overlap in the acquired map image.

In the example of FIG. 5, the display control unit 125 causes the display device 31 to display images 300-1 to 300-3 indicating the target trajectories K-1 to K-3, respectively, so that these images overlap on the map image. The images 300-1 to 300-3 are, for example, images including predetermined figures such as arrows, but the present invention is not limited thereto. Symbols, shapes, color, lines, blinking and luminance adjustment of a predetermined region (for example, flash display), or the like may be used.

The display control unit 125 causes the display device 31 to display an image 310 in which information indicating that the own vehicle M is not able to travel is associated with a target trajectory along which travel is not possible. For example, the display control unit 125 causes the display device 31 to display an image in which information indicating that the own vehicle M is not able to travel is associated with the position of a lane change destination of the own vehicle M with regard to the trajectory along which travel is not possible.

In the example of FIG. 5, the display control unit 125 causes the display device 31 to display images 310-1 and 310-2 such as “Can't go” in association with the images 300-1 and 300-2 indicating the target trajectories along which the own vehicle M is not able to travel.

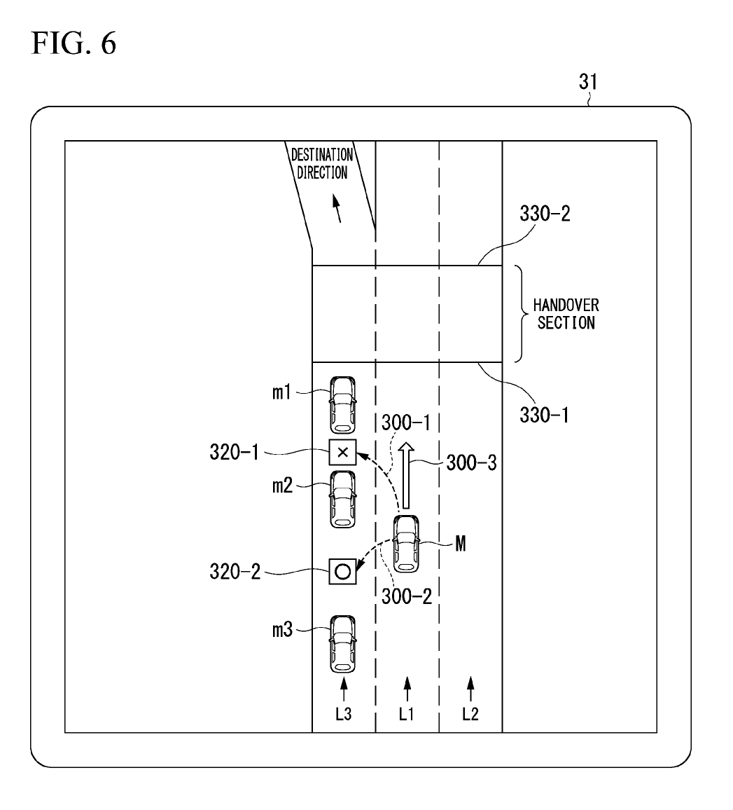

In FIG. 6, the images 300-1 and 300-2 indicating the target trajectories along which the own vehicle M is not able to travel are trajectories in a case in which the own vehicle M is not able to travel along the target trajectory generated at the time of attempting to change lanes. The image 300-3 indicating a trajectory along which the own vehicle M is able to travel is an alternative trajectory generated when the own vehicle M is not able to travel along the target trajectory generated at the time of attempting to change lanes. The display control unit 125 can display the images 300-1 to 300-3 so that an occupant can recognize that the own vehicle M attempts to change lanes but is not able to change lanes and can recognize a trajectory along which the own vehicle is able to travel when the own vehicle M is not able to change lanes.

Thus, the occupant can easily ascertain the plurality of target trajectory candidates generated at the current time and whether travel is possible with regard to each target trajectory and can ascertain a situation of the own vehicle M more specifically during the automated driving. Accordingly, the display control unit 125 can improve a sense of safety of the occupant with regard to the automated driving. The display control unit 125 may display the images 300-1 and 300-2 indicating the target trajectories along which the own vehicle M is not able to travel and the image 300-3 indicating the target trajectory along which the own vehicle M is able to travel, with different marks, figures, signs, shapes, or the like.

FIG. 6 is a diagram illustrating an example in which an image in which information indicating whether travel is possible is indicated by a mark on a road of a lane change destination is displayed. In the example of FIG. 6, the display control unit 125 overlaps an image 320-1 of an “x” mark indicating that travel is not possible on a road between the peripheral vehicles m1 and m2 which prevent the vehicle from traveling along the target trajectory of the lane change destination indicated by the image 300-1. The display control unit 125 may overlap an image 320-2 such as an “o” mark indicating that travel is possible on a road of a lane destination when travel is possible along the target trajectory of the lane change destination indicated by the image 300-2.

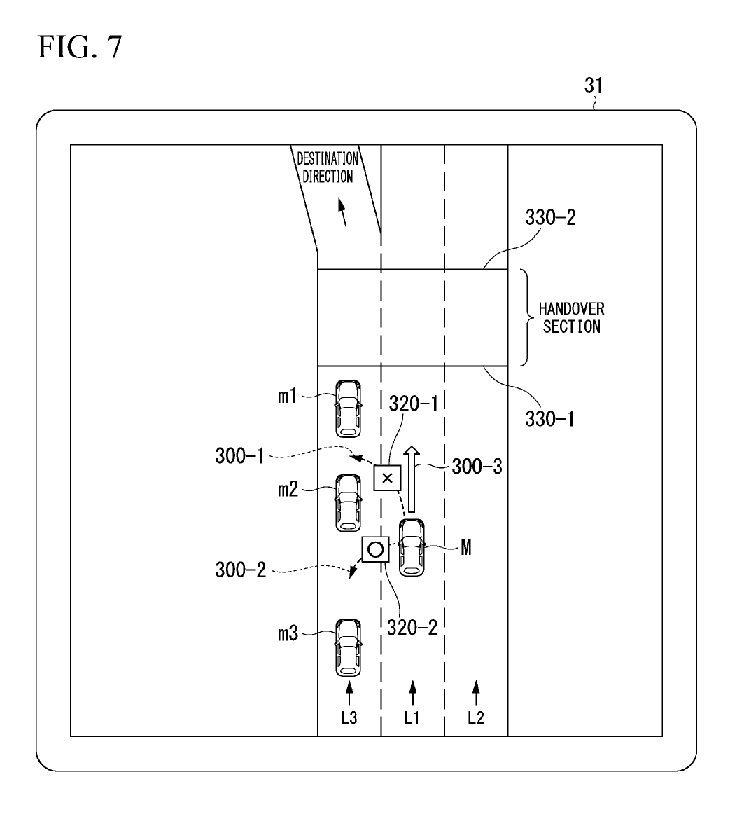

The display control unit 125 may cause the display device 31 to display an image indicating a target trajectory and an image indicating that travel is possible or travel is not possible so that these images overlap. FIG. 7 is a diagram illustrating an example in which an image indicating a target trajectory and an image indicating that the vehicle is able to travel or not able to travel are displayed to overlap. In the example of FIG. 7, the display control unit 125 causes the image 320-1 of the “x” mark indicating that travel is not possible to overlap the image 300-1. The display control unit 125 may cause the image 320-2 such as the “o” mark indicating that travel is possible to overlap the image 300-2. The display control unit 125 may cause the display device 31 to display a combination of some or all of the above-described images 310 to 320.

When there are a plurality of target trajectories along which travel is possible among the target trajectories displayed on the display device 31, the display control unit 125 may receive the target trajectories along which travel is possible and which are selected by the occupant and output information regarding the received target trajectories to the travel control unit 131. In this case, for example, when the occupant touches a portion in which a target trajectory along which travel is possible is displayed on a screen of the display device 31 or a portion in which an image indicating that travel is possible is displayed, the display control unit 125 receives the target trajectory selected by the occupant. Thus, the occupant can cause the own vehicle M to travel along a preferred trajectory among the trajectories along which travel is possible.

The display control unit 125 may associate information indicating whether travel is possible with the peripheral vehicles m1 to m3 rather than associating the information indicating whether travel is possible with the target trajectories, as described above. Thus, the occupant can easily ascertain peripheral vehicles which prevent the vehicle from traveling.

The display control unit 125 may alternately switch the images 300-1 and 300-2 regarding the target trajectories along which the own vehicle M is not able to travel and the image 300-3 regarding the target trajectory along which the own vehicle M is able to travel at predetermined timings and may cause the display device 31 to display the images. The predetermined timings may be, for example, predetermined time intervals or may be switching operations by the various operation switches 33. Thus, the occupant can easily distinguish the target trajectory along which the vehicle is able to travel from the target trajectory along which the vehicle is not able to travel. When there are the plurality of target trajectories along which the own vehicle M is able to travel and the plurality of target trajectories along which the own vehicle M is not able to travel, the display control unit 125 may switch the target trajectories at predetermined timings and cause the display device 31 to display the target trajectories in sequence.

In the above-described example, the display example of the case in which the change in lanes is included in the trajectory generated in advance and the display control unit 125 is not able to change lanes has been described, but the present invention is not limited thereto. For example, the display control unit 125 may cause the images 310 and 320 or the like to be displayed similarly when an operation indicating that the lane is changed by the occupant of the own vehicle M is input at a branching point of a case in which the trajectory generated in advance is straight, and the lane change is not possible. In this case, the action plan generation unit 123 may generate a plurality of target trajectory candidates using a reception of the operation of changing lanes from the occupant by the driving operator 80 or the like as an opportunity.

The display control unit 125 may cause the display device 31 to display an image indicating a timing at which it is confirmed whether a predetermined event is performed. For example, the display control unit 125 may cause the display device 31 to display an image indicating each piece of information when the information regarding a timing at which the handover control unit 124 starts a handover request and a timing at which the handover is completed. A timing at which the information is displayed is, for example, a timing at which a distance between the own vehicle M and a spot in which the handover request starts is a predetermined distance or less.

In the examples of FIGS. 5 to 7, the display control unit 125 causes the display device 31 to display an image 330-1 of a line indicating a notification start position of a handover request and an image 330-2 of a line indicating a position at which handover is completed. The display control unit 125 may cause a handover section interposed between the images 330-1 and 330-2 (a switching section from the automated driving to the manual driving) to be displayed and highlighted with a color different from a background color, a shape, or the like.

In this way, when the notification start position of the handover request and the position at which the handover is completed are displayed, the occupant can have time to get ready to perform the manual driving before the handover request is notified of. Further, the occupant can ascertain a timing at which the own vehicle M notifies the occupant of the handover request more specifically in automated driving control. Accordingly, it is possible to improve a sense of safety of the occupant with regard to the automated driving.

The display control unit 125 may cause the display device 31 to display a handover request supplied by an instruction from the handover control unit 124 when the own vehicle M arrives at the notification start position of the handover request (when a notification start timing of the handover request arrives).

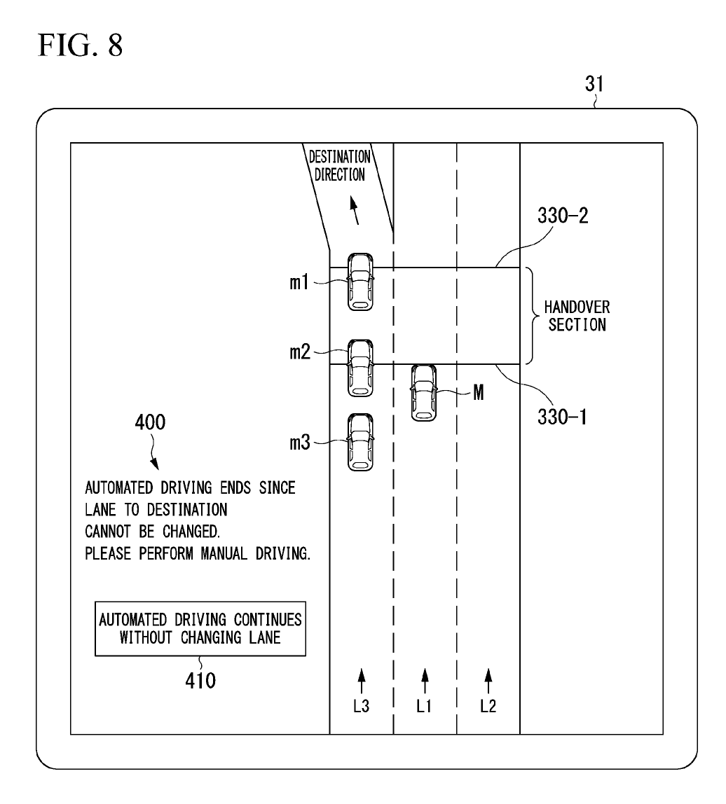

FIG. 8 is a diagram illustrating a display example of information regarding a handover request. In the example of FIG. 8, the display control unit 125 causes the display device 31 to display information 400 regarding a handover request for the occupant of the own vehicle M. The information 400 regarding the handover request displayed on the display device 31 is, for example, message information such as “Automated driving is ending because the lane to the destination cannot be changed. Please perform manual driving,” as illustrated. The information 400 regarding the handover request is preferably displayed at a position at which the information 400 does not overlap the map information such as travel lanes, the own vehicle M, and the peripheral vehicles displayed on the display device 31.

In this way, by displaying the information 400 regarding the handover request on the display device 31, it is possible to cause the occupant to perform an operation of switching to the manual driving and notify the occupant of a reason for performing the manual driving.

The display control unit 125 deletes the images 300-1 to 300-3 indicating the target trajectories K-1 to K-3 from the display image when the own vehicle M arrives at the notification start position of the handover request. In the example of FIG. 8, the display control unit 125 deletes the images 300-1 to 300-3 indicating the target trajectories K-1 to K-3 from the images displayed on the display device 31. Thus, the occupant can be more clearly notified that the handover request is notified of. The automated driving control unit 100 may perform sound output control such that the information 400 regarding the handover request is output as a sound by the speaker 32.

Further, the display control unit 125 causes the display device 31 to present a GUI switch 410 for receiving an instruction to cancel the handover request and continue the automated driving when the display device 31 is caused to display the information 400 regarding the handover request.

When a cancellation operation through the GUI switch 410 is received, the action plan generation unit 123 cancels the handover request and continues the automated driving. Specifically, the action plan generation unit 123 generates a target trajectory other than the target trajectory suitable for a route to the present destination and performs the automated driving along the generated target trajectory in order for the own vehicle M to arrive at the destination without changing lanes to the travel lane L3.

Thus, for example, when the own vehicle M is traveling on an expressway and an interchange in the destination direction is congested, the GUI switch 410 displayed on the display device 31 is pressed so that the automated driving for getting off in a next interchange continues, and therefore the action plan can be changed smoothly.

For example, the GUI switch 410 is preferably displayed near a position at which the GUI switch 410 does not overlap the map information such as travel lanes, the own vehicle M, and the peripheral vehicles displayed on the display device 31 and the information 400 regarding the handover request is displayed. Instead of the GUI switch 410, mechanical switches may be installed as the various operation switches 33. The display control unit 125 may cause message information indicating that the automated driving continues to be displayed in the GUI switch 410, as illustrated in FIG. 8.

The display control unit 125 may cause the display device 31 to display information regarding a target trajectory for an emergency stop supplied by the action plan generation unit 123.

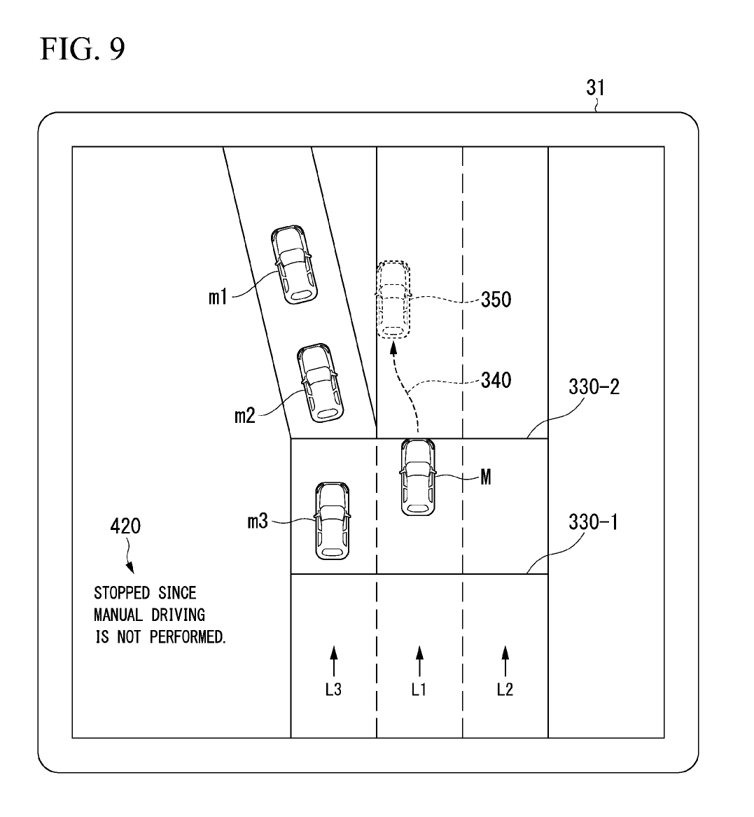

FIG. 9 is a diagram illustrating a display example of a target trajectory for an emergency stop. The display control unit 125 causes the display device 31 to display an image indicating the target trajectory of an emergency stop overlapping on an image displayed on the display device 31 when the target trajectory for an emergency stop supplied by the action plan generation unit 123 is supplied. The display control unit 125 may cause the display device 31 to display an image indicating a stop schedule position of the own vehicle M decided based on the target trajectory for an emergency stop.

In the example of FIG. 9, the display control unit 125 causes the display device 31 to display an image 340 indicating the target trajectory for an emergency stop and an image 350 indicating the stop schedule position in association with a current position of the own vehicle M. As illustrated in FIG. 9, the target trajectory for an emergency stop is a target trajectory for stopping the own vehicle M at a safe position. The safe position is, for example, an emergency parking area, a road shoulder, or a road side area. The image 340 indicating the target trajectory for an emergency stop is, for example, an image including a predetermined figure such as an arrow. The image 350 indicating the stop schedule position is, for example, an image corresponding to the shape of the own vehicle M. The images 340 and 350 may be images with other figures, symbols, shapes, color, lines, blinking and luminance adjustment of a predetermined region, or the like.

The display control unit 125 causes the display device 31 to display message information 420 indicating a reason or the like for an emergency stop of the own vehicle M along with the images 340 and 350. Thus, the occupant can easily ascertain that the driving control of an emergency stop is performed since the manual driving is not performed.

The second control unit 130 includes, for example, a travel control unit 131 and a switching control unit 132. The travel control unit 131 controls the travel driving power output device 200, the brake device 210, and the steering device 220 such that the own vehicle M passes along the target trajectory generated by the action plan generation unit 123 at a scheduled time.

For example, the switching control unit 132 alternately switches each driving mode of the automated driving and the manual driving based on a signal input from an automated driving switching switch installed in the various operation switches 33 of the HMI 30. The switching control unit 132 switches the driving mode of the own vehicle M from the automated driving to the manual driving, for example, based on an operation of instructing the driving operator 80 such as an acceleration pedal, a brake pedal, a steering wheel, or the like to accelerate, decelerate, or steer.

The switching control unit 132 switches the driving mode of the own vehicle M from the automated driving to the manual driving based on a switching instruction by the handover control unit 124.

The travel driving power output device 200 outputs travel driving power (torque) for traveling the vehicle to a driving wheel. The travel driving power output device 200 includes, for example, a combination of an internal combustion engine, an electric motor and a transmission, and an electronic control unit (ECU) controlling these units. The ECU controls the foregoing configuration in accordance with information input from the travel control unit 131 or information input from the driving operator 80.

The brake device 210 includes, for example, a brake caliper, a cylinder that transmits a hydraulic pressure to the brake caliper, an electronic motor that generates a hydraulic pressure in the cylinder, and a brake ECU. The brake ECU controls the electric motor in accordance with information input from the travel control unit 131 or information input from the driving operator 80 such that a brake torque in accordance with a brake operation is output to each wheel. The brake device 210 may include a mechanism that transmits a hydraulic pressure generated in response to an operation of the brake pedal included in the driving operator 80 to the cylinder via a master cylinder as a backup. The brake device 210 is not limited to the above-described configuration and may be an electronic control type hydraulic brake device that controls an actuator in accordance with information input from the travel control unit 131 such that a hydraulic pressure of the master cylinder is transmitted to the cylinder. The brake device 210 may include brake devices of a plurality of systems in consideration of safety.

The steering device 220 includes, for example, a steering ECU and an electric motor. The electric motor applies a force to, for example, a rack and pinion mechanism to change a direction of a steering wheel. The steering ECU drives the electric motor to change the direction of the steering wheel in accordance with information input from the travel control unit 131 or information input from the driving operator 80.

### Process Flow

Hereinafter, various vehicle control examples by the vehicle system 1 according to an embodiment will be described.

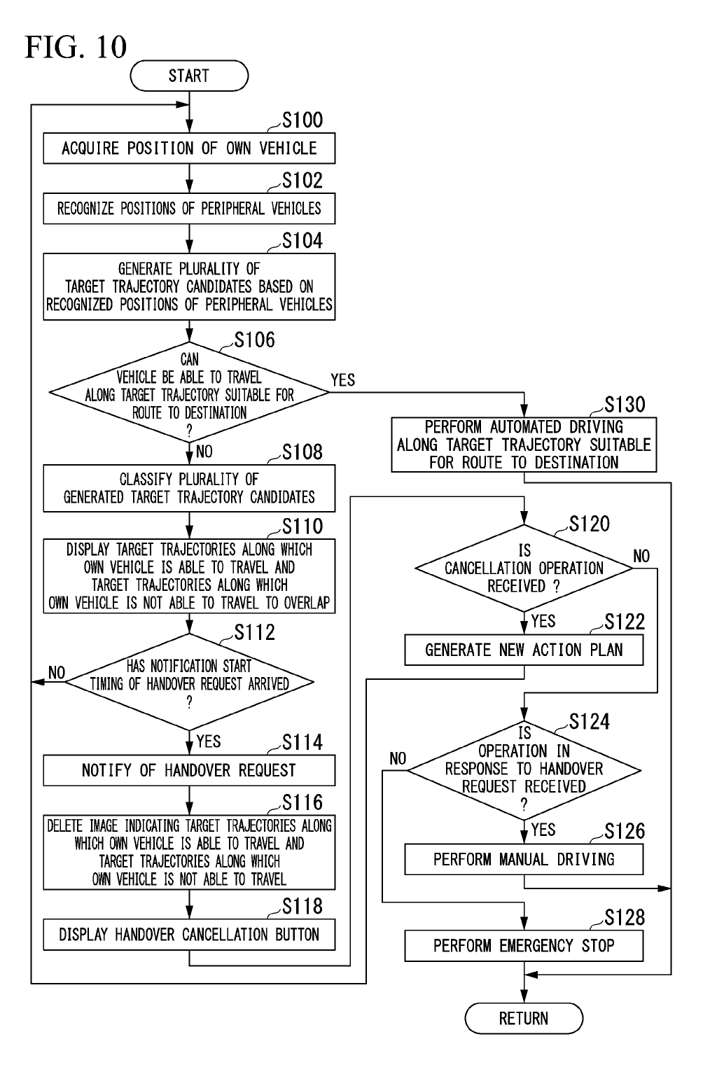

FIG. 10 is a flowchart illustrating an example of a vehicle control process according to an embodiment. The process of FIG. 10 is an example of a vehicle control process of the own vehicle M while the automated driving is performed and is repeatedly performed at a predetermined timing while the automated driving is performed.

First, the own vehicle position recognition unit 122 acquires a position of the own vehicle M (step S100). Subsequently, the external-world recognition unit 121 recognizes positions of peripheral vehicles of the own vehicle M (step S102). Subsequently, the action plan generation unit 123 generates a plurality of target trajectory candidates based on the positions of the peripheral vehicles recognized by the external-world recognition unit 121 (step S104).

Subsequently, the action plan generation unit 123 determines whether the vehicle is able to travel along the target trajectory suitable for a route to a destination among the plurality of generated target trajectory candidates (step S106). When the vehicle is not able to travel along the target trajectory suitable for the route to the destination, the action plan generation unit 123 classifies the plurality of generated target trajectory candidates into target trajectories along which the own vehicle M is able to travel and target trajectories along which the own vehicle M is not able to travel (step S108).

Subsequently, the display control unit 125 causes the display device 31 to display information regarding the target trajectories along which the own vehicle M is able to travel and target trajectories along which the own vehicle M is not able to travel so that the information overlaps a map image acquired from the second map information 62 or the like using the position of the own vehicle M as a reference (step S110).

Subsequently, the handover control unit 124 determines whether a notification start timing of a handover request arrives based on the current position of the own vehicle M (step S112). When the notification start timing of the handover request has not arrived, the process returns to step S100.

Conversely, when the notification start timing of the handover request has arrived, the display control unit 125 notifies the occupant of the handover request by causing the display device 31 to display the handover request (step S114). Subsequently, the display control unit 125 deletes the images indicating the target trajectories along which the own vehicle M is able to travel and the target trajectories along which the own vehicle M is not able to travel from the display image (step S116).

Subsequently, the display control unit 125 causes the display device 31 to display a handover cancellation button (step S118). Subsequently, the action plan generation unit 123 determines whether to receive a cancellation operation through the handover cancellation button (step S120). When the cancellation operation is received, the action plan generation unit 123 generates a new action plan based on the current position of the own vehicle M (step S122) and the process returns to step S100. Thus, the automated driving of the own vehicle M continues.

Conversely, when the handover cancellation operation is not received, the handover control unit 124 determines whether an operation in response to the handover request by the occupant is received (step S124). When the operation in response to the handover request is received, the switching control unit 132 switches the driving mode from the automated driving to the manual driving (step S126). Conversely, when the operation in response to the handover request is not received, the travel control unit 131 causes the own vehicle M to perform an emergency stop (step S128).

When the vehicle is able to travel along the target trajectory suitable for the route to the destination in the process of step S106, the action plan generation unit 123 performs the automated driving along the target trajectory suitable for the route to the destination (step S130). Thus, the process of the present flowchart ends.

According to the vehicle control system, the vehicle control method, and the vehicle control program according to the above-described embodiments, the occupant can ascertain the target trajectory candidates at the current time. Since the trajectories along which the own vehicle M is able to travel and the trajectories along which the own vehicle M is not able to travel are displayed, the occupant can ascertain a situation of the vehicle during the automated driving more specifically. Accordingly, it is possible to improve a sense of safety of the occupant with regard to the automated driving.

According to the embodiments, the occupant can easily ascertain the peripheral vehicles which prevent the vehicle from traveling, the timings at which the handover request is notified of, and the like from the display content. According to the embodiments, by displaying the GUI switch for cancelling the handover on the screen, it is possible to continue the automated driving of the own vehicle M through a simple operation of the occupant even at a timing of the handover.

While preferred embodiments of the invention have been described and illustrated above, it should be understood that these are exemplary of the invention and are not to be considered as limiting. Additions, omissions, substitutions, and other modifications can be made without departing from the spirit or scope of the present invention. Accordingly, the invention is not to be considered as being limited by the foregoing description, and is only limited by the scope of the appended claims.

### REFERENCE SIGNS LIST

1 Vehicle system

10 Camera

12 Radar device

14 Finder

16 Object recognition device

20 Communication device

30 HMI

50 Navigation device

60 MPU

70 Vehicle sensor

80 Driving operator

90 Vehicle interior camera

100 Automated driving control unit

120 First control unit

121 External-world recognition unit

122 Own vehicle position recognition unit

123 Action plan generation unit (trajectory generation unit)

124 Handover control unit

125 Display control unit

130 Second control unit

131 Travel control unit

132 Switching control unit

200 Travel driving power output device

210 Brake device

220 Steering device

M Own vehicle

What is claim is:

1. A vehicle control system comprising:
an external-world recognition unit configured to recognize a position of a peripheral vehicle of a vehicle;
a trajectory generation unit configured to generate a plurality of trajectory candidates based on the position of the peripheral vehicle recognized by the external-world recognition unit; and
a display control unit configured to cause a display unit to display both an image indicating a trajectory along which the vehicle is able to travel and an image indicating a trajectory along which the vehicle is not able to travel among the plurality of trajectory candidates generated by the trajectory generation unit.

2. The vehicle control system according to claim 1, wherein the display control unit causes the display unit to display an image in which information indicating that the vehicle is not able to travel is associated with the trajectory along which the vehicle is not able to travel.

3. The vehicle control system according to claim 1, wherein the display control unit causes the display unit to display an image in which information indicating that the vehicle is not able to travel is associated with a peripheral vehicle which prevents the vehicle from traveling with regard to the trajectory along which the vehicle is not able to travel.

4. The vehicle control system according to claim 1, wherein the display control unit causes the display unit to display an image in which information indicating that the vehicle is not able to travel is associated with a position of a lane change destination of the vehicle with regard to the trajectory along which the vehicle is not able to travel.

5. The vehicle control system according to claim 1, wherein the display control unit causes the display unit to display an image in which between the trajectory along which the vehicle is able to travel and the trajectory along which the vehicle is not able to travel are alternately switched

6. The vehicle control system according to claim 1, wherein the display control unit causes the display unit to display the image indicating the trajectory along which the vehicle is able to travel and the trajectory along which the vehicle is not able to travel when a predetermined event is activated and further display an image indicating a timing at which it is confirmed whether the predetermined event is performed on the display unit.

7. The vehicle control system according to claim 6, wherein the display control unit performs a request for allowing an occupant of the vehicle to perform manual driving when the timing at which it is confirmed whether the predetermined event is activated arrives in a state in which the vehicle is not able to travel along a trajectory suitable for a route to a preset destination among the plurality of trajectory candidates generated by the trajectory generation unit.

8. The vehicle control system according to claim 7, further comprising:
an automated driving control unit configured to perform automated driving of the vehicle based on a trajectory generated by the trajectory generation unit,
wherein the automated driving control unit continues the automated driving along the trajectory along which the vehicle is able to travel and which is displayed on the display unit when a cancellation operation of cancelling the request is received.

9. The vehicle control system according to claim 8, wherein the display control unit further causes the display unit to present a GUI switch for cancelling the request when the display unit is caused to display information regarding a request for allowing an occupant of the vehicle to perform manual driving, and the automated driving control unit performs the automated driving along a trajectory other than a trajectory suitable for a route to a preset destination when a cancellation operation of cancelling the request is received through the GUI switch.

10. A vehicle control method comprising:
recognizing a position of a peripheral vehicle of a vehicle by an in-vehicle computer;
generating a plurality of trajectory candidates based on the recognized position of the peripheral vehicle by the in-vehicle computer; and
causing a display unit to display both an image indicating a trajectory along which the vehicle is able to travel and an image indicating a trajectory along which the vehicle is not able to travel among the plurality of generated trajectory candidates by the in-vehicle computer.

11. A vehicle control program causing an in-vehicle computer to:
recognize a position of a peripheral vehicle of a vehicle;
generate a plurality of trajectory candidates based on the recognized position of the peripheral vehicle; and
cause a display unit to display both an image indicating a trajectory along which the vehicle is able to travel and an image indicating a trajectory along which the vehicle is not able to travel among the plurality of generated trajectory candidates.
